(19) United States
(12) Patent Application Publication
(10) Pub. No.: US 2020/0180678 A1
(43) Pub. Date: Jun. 11, 2020

(54) STEERING SUPPORT DEVICE

(71) Applicant: DENSO CORPORATION, Kariya-city, Aichi-pref. (JP)

(72) Inventors: Daiji WATANABE, Kariya-city, Aichi-pref. (JP); Hisaya AKATSUKA, Kariya-city, Aichi-pref. (JP)

(21) Appl. No.: 16/321,996

(22) PCT Filed: Jul. 28, 2017
(86) PCT No.: PCT/JP2017/027503

§ 371 Date: Jan. 30, 2019

(30) Foreign Application Priority Data
Aug. 1, 2016 (JP) 2016-151210

(51) Int. Cl. B62D 5/04

(52) U.S. Cl. CPC B62D 5/0463; B62D 5/0424

(57) ABSTRACT

A position prediction unit calculates a predicted position which is a position of the vehicle on the map at a certain point of time after the present time based on the map. An assist calculation unit calculates an assist control amount of the steering operation based on the road shape at the predicted position which can be identified from the map. An operation amount acquisition unit acquires an operation amount of the steering. An adjustment unit adjusts the assist control amount according to the operation amount.

### CROSS REFERENCE TO RELATED APPLICATION

The present international application claims priority based on Japanese Application No. 2016-151210 filed to the Japan Patent Office on Aug. 1, 2016, and the entire contents of which are incorporated herein by reference.

### TECHNICAL FIELD

The present disclosure relates to a technique for supporting steering operations made by a driver of a vehicle.

### BACKGROUND ART

There are known steering support devices configured to support steering operations made by a driver of a vehicle. The steering support device described in PTL 1 sets a line-of-sight point, which is the point of a change from a state in which the driver cannot see an area of the road ahead of him/her to a state in which the driver can see, based on the gradient information of the road stored in a map database in the vehicle. Steering control for adjusting the steering ratio is performed so that the driver does not abruptly perform steering operation in a hurry when it becomes possible for the driver to see the area ahead after the vehicle passes through the line-of-sight point, and as a result cause the steering angle of the steerable wheels to change abruptly. The steering ratio mentioned here is the ratio of the steering angle of the steerable wheels to the rotation angle of the steering wheel.

### CITATION LIST

### Patent Literature

### SUMMARY OF THE INVENTION

A steering support device can be envisaged that calculates the assist control amount based on the steering angle of the steering wheel at the present time, and the target steering angle which is the steering angle to be achieved estimated as the steering angle after lapse of a predetermined time from the present time. The assist control amount is a control amount of the control for assisting the steering force of the driver. Further, the assist control amount mentioned here includes not only the magnitude of the assist control force but also the steering direction. A configuration is conceivable in which the target steering angle, and further the assist control amount, are computed based on a preset set of information such as information on the road shape, and the steering control is executed based on the assist control amount.

However, as a result of detailed examination by the inventor, the following problem was found with the above configuration. That is, when the driver intends to respond to a situation that has not been taken into consideration in the calculation of the assist control amount, such as when the driver abruptly performs steering operation in an attempt to avoid an obstacle, the steering operation of the driver may be hindered by the steering control.

An aspect of the present disclosure provides a technique that prevents the steering control from hindering the steering operation of the driver when the driver intends to respond to a situation that has not been taken into consideration in the calculation of the assist control amount.

One mode of the present disclosure is a steering support device configured to support a steering operation made by a driver of a vehicle, comprising a map acquisition unit, a position prediction unit, an assist calculation unit, an operation amount acquisition unit, an adjustment unit, and an execution unit. The map acquisition unit acquires map data representing a map. The position prediction unit calculates a predicted position which is a position of the vehicle on the map at a certain point of time after the present time based on the map. The assist calculation unit calculates an assist control amount of the steering operation based on the road shape at the predicted position which can be identified from the map. The operation amount acquisition unit acquires an operation amount of the steering. The adjustment unit adjusts the assist control amount according to the operation amount. The execution unit executes a steering control based on the assist control amount adjusted by the adjustment unit.

According to such a configuration, the assist control amount is adjusted according to the operation amount performed by the driver. Thus, it is possible to prevent the steering control hindering the steering operation of the driver when the driver intends to respond to a situation that has not been taken into consideration in the calculation of the assist control amount.

Another mode of the present disclosure is a steering support method executed by a steering support device configured to support a steering operation made by a driver of a vehicle. The steering support method comprises acquiring map data representing a map, and calculating a predicted position which is a position of the vehicle on the map at a certain point of time after the present time based on the map. The steering support method also comprises calculating an assist control amount of the steering operation based on a road shape at the predicted position which can be identified from the map, and acquiring an operation amount of the steering. The steering support method also comprises adjusting the assist control amount according to the operation amount, and executing a steering control based on the adjusted assist control amount.

According to such a method, the same effects as those of the steering support device described above can be obtained.

It is to be noted that the reference numbers in parentheses in the claims merely indicate relationships between those elements and the specific means described with respect to the embodiment described below as one mode of the present disclosure, and do not limit the technical scope of the present disclosure.

### BRIEF DESCRIPTION OF THE DRAWINGS

FIG. 1 is a block diagram showing the configuration of the EPS system according to the first embodiment.

FIG. 2 is a block diagram showing the configuration of the EPSECU according to the first embodiment.

FIG. 3 is a block diagram showing the configuration of the adjustment unit according to the first embodiment.

FIG. 4 is a diagram showing the gain map according to the first embodiment.

FIG. 5 is a flowchart showing the steering support process.

FIG. 6 is a flowchart of the adjustment processing according to the first embodiment.

FIG. 7 is a block diagram showing the configuration of the adjustment unit according to the second embodiment.

FIG. 8 is a diagram showing the same-direction gain map.

FIG. 9 is a diagram showing the reverse-direction gain map.

FIG. 10 is a flowchart of the adjustment processing according to the second embodiment.

FIG. 11 is a block diagram showing the configuration of the EPS system according to the third embodiment.

FIG. 12 is a block diagram showing the configuration of the EPS ECU according to the third embodiment.

FIG. 13 is a block diagram showing the configuration of the adjustment unit according to the third embodiment.

FIG. 14 is a flowchart of the adjustment processing according to the third embodiment.

### DESCRIPTION OF THE EMBODIMENTS

An embodiment for implementing the present disclosure will be described with reference to the drawings.

[1. First Embodiment]

[1-1. Configuration]

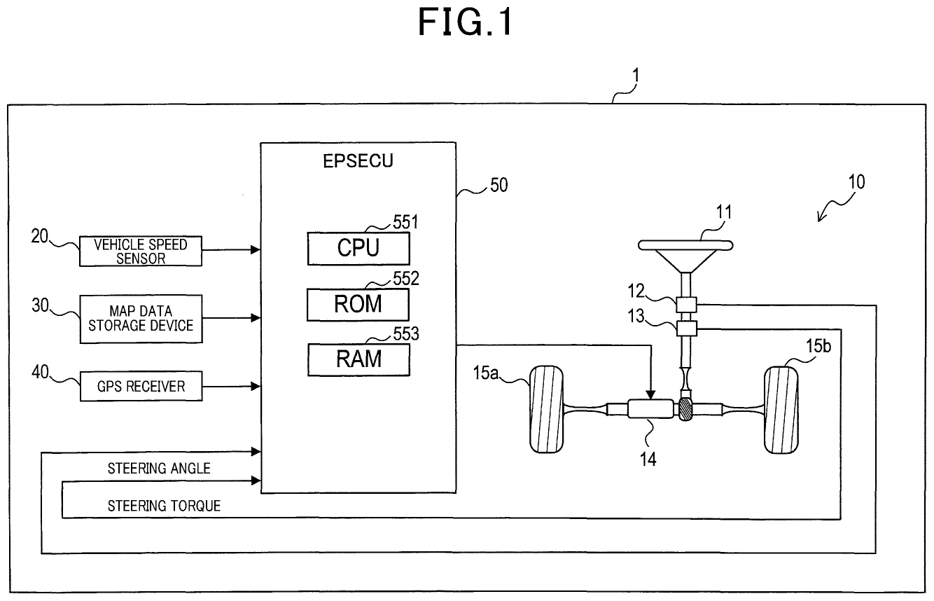

An electric power steering system (hereinafter referred to as an EPS system) 1 shown in FIG. 1 is a system for supporting the steering operation made by a driver of a vehicle. Hereinafter, the vehicle on which the EPS system 1 is mounted will be referred to as “own vehicle.” The EPS system 1 includes a steering mechanism 10, a vehicle speed sensor 20, a map data storage device 30, a GPS receiver 40, and an electric power steering ECU (EPSECU) 50.

The steering mechanism 10 includes a steering wheel 11, a steering angle sensor 12, a torque sensor 13, a motor 14, and steerable wheels 15a and 15b.

The steering wheel 11 is a rotatable member and is rotated by the driver to perform steering operation.

The steering angle sensor 12 is a sensor for detecting the steering angle of the steering wheel 11. The steering angle sensor 12 outputs the detection result to the EPSECU 50.

The torque sensor 13 is a sensor for detecting the steering torque. The torque sensor 13 outputs the detection result to the EPSECU 50.

The motor 14 is the power source for assisting the steering force of the steering wheel 11 applied by the driver. The motor 14 is driven by the EPSECU 50 as described later.

The steerable wheels 15a and 15b are rotated in response to the operation of the steering wheel 11 made by the driver.

On the other hand, the vehicle speed sensor 20 is a sensor for detecting the traveling speed of the own vehicle. The vehicle speed sensor 20 outputs the detection result to the EPSECU 50.

The map data storage device 30 is a device configured to store map data representing a map. The map data storage device 30 outputs the map data to the EPSECU 50. The map represented by the map data includes information on the road shape.

The GPS receiver 40 is a device configured to locate the current position of the own vehicle by receiving transmission radio waves from a GPS satellite via a GPS antenna (not shown). The GPS receiver 40 outputs the current position of the own vehicle to the EPSECU 50.

The EPSECU 50 includes a microcomputer including a CPU 551, ROM 552, RAM 553, and the like. The EPSECU 50 calculates the driving amount of the motor 14 and controls the motor 14 according to the calculation result, thereby assisting the force of the driver for rotating the steering wheel 11, and thus the force for steering the steerable wheels 15a, 15b.

In addition, the EPSECU 50 calculates the target steering angle as a steering support for supporting a part of the steering operation of the driver, and executes control for biasing the rotation of the steering wheel 11 so that the steering angle reaches the target steering angle. The target steering angle is the steering angle to be achieved estimated as the steering angle after lapse of a predetermined time from the present time. This steering support is started or ended by an operation based on the intention of the driver.

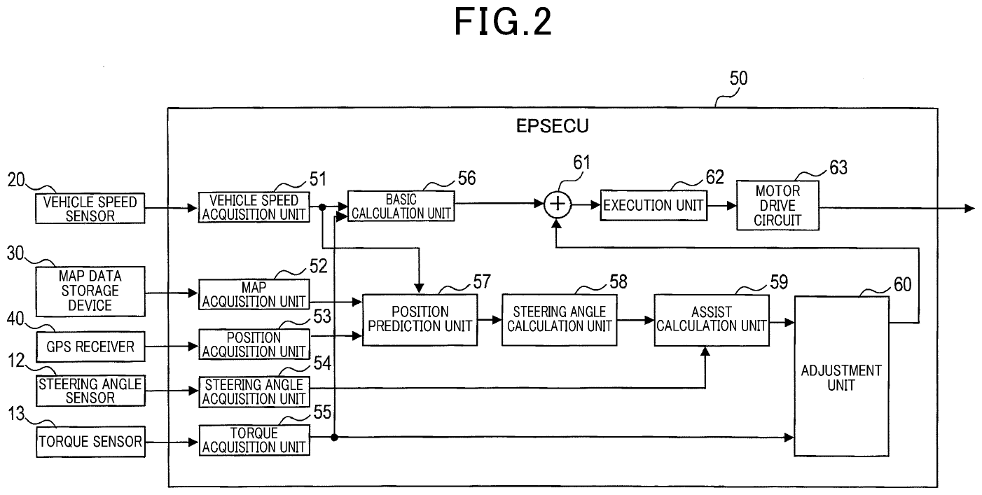

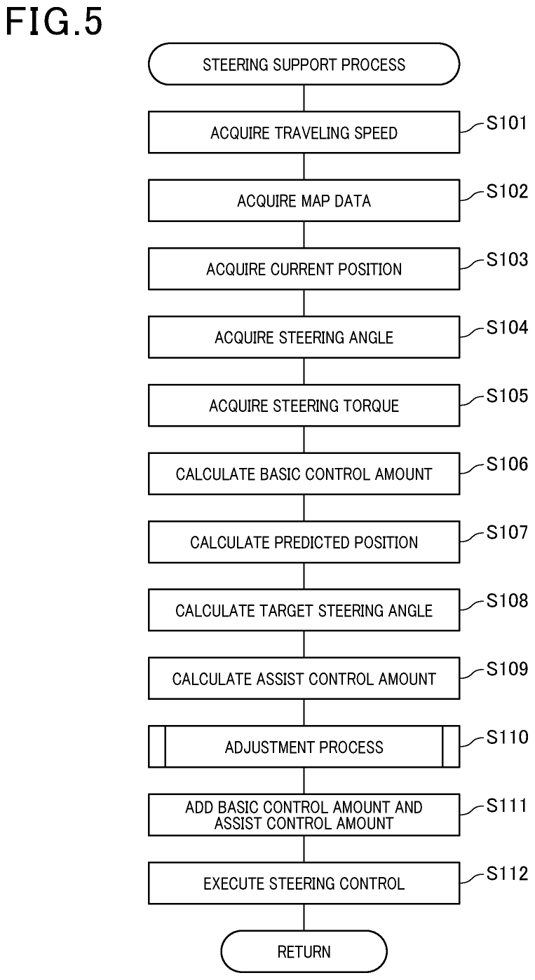

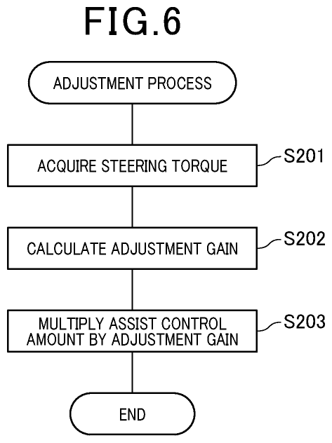

The various functions of the EPSECU 50 are realized by the CPU 551 executing a program stored in a non-transitory tangible computer-readable storage medium such as the ROM 552. A method corresponding to the programs is executed by execution of the program. Also, a steering support process shown in FIG. 5 and FIG. 6 to be described later is executed by executing this program. As shown in FIG. 2, the EPSECU 50 executes the steering support process to thereby serve as a vehicle speed acquisition unit 51, a map acquisition unit 52, a position acquisition unit 53, a steering angle acquisition unit 54, a torque acquisition unit 55, a basic calculation unit 56, a position prediction unit 57, a steering angle calculation unit 58, an assist calculation unit 59, an adjustment unit 60, an addition unit 61, and an execution unit 62. Further, the EPSECU 50 includes a motor drive circuit 63 which is a hardware configuration.

The vehicle speed acquisition unit 51 acquires the traveling speed of the own vehicle from the vehicle speed sensor 20.

The map acquisition unit 52 acquires the map data from the map data storage device 30.

The position acquisition unit 53 acquires the current position of the own vehicle from the GPS receiver 40.

The steering angle acquisition unit 54 acquires the steering angle from the steering angle sensor 12.

The torque acquisition unit 55 acquires the steering torque from the torque sensor 13.

The basic calculation unit 56 calculates, based on the steering torque acquired by the torque acquisition unit 55 and the traveling speed of the own vehicle acquired by the vehicle speed acquisition unit 51, a basic control amount which is a control amount used in the control for reducing the load when the driver rotates the steering wheel 11. This basic control amount is a control amount calculated also in a normal power steering system in which steering support cannot be executed. Specifically, the larger the steering torque is, the larger the calculated basic control amount is. That is, the basic control amount is calculated such that the steering torque applied by the motor 14 in the direction for assisting the rotation of the steering wheel 11 increases. Further, the larger the traveling speed of the own vehicle, the smaller the calculated basic control amount. In such manner, the motor 14 generates auxiliary steering torque corresponding to the steering torque applied to the steering wheel 11.

Based on the traveling speed of the own vehicle acquired by the vehicle speed acquisition unit 51, the map represented by the map data acquired by the map acquisition unit 52, and the current position of the own vehicle acquired by the position acquisition unit 53, the position prediction unit 57 calculated the predicted position. The predicted position is the position of the own vehicle on the map after lapse of a predetermined time from the present time. In other words, this predicted position is the position of the own vehicle on the map at a predetermined point of time that is later than the present point of time. More specifically, the position prediction unit 57 calculates the predicted position as the position of the own vehicle on the map after it has traveled for a predetermined time along the road on the map from the current position at the acquired traveling speed.

The steering angle calculating unit 58 calculates the target steering angle based on the road shape at the predicted position that can be identified from the map represented by the map data acquired by the map acquiring unit 52. In the present embodiment, the steering angle calculating unit 58 calculates the curvature of the road at the predicted position based on the road shape, and calculates, as the target steering angle, a steering angle suitable for the calculated curvature, in other words, a steering angle that would be required when the own vehicle travels the road with that curvature.

The assist calculation unit 59 calculates the assist control amount on the basis of the steering angle acquired by the steering angle acquisition unit 54 and the target steering angle calculated by the steering angle calculation unit 58. The assist control amount is a control amount of the control carried out in the steering support to assist the steering force of the driver. The assist control amount is calculated as a control amount according to the difference between the acquired steering angle and the calculated target steering angle. The assist control amount mentioned here includes not only the magnitude of the assist control force but also the steering direction.

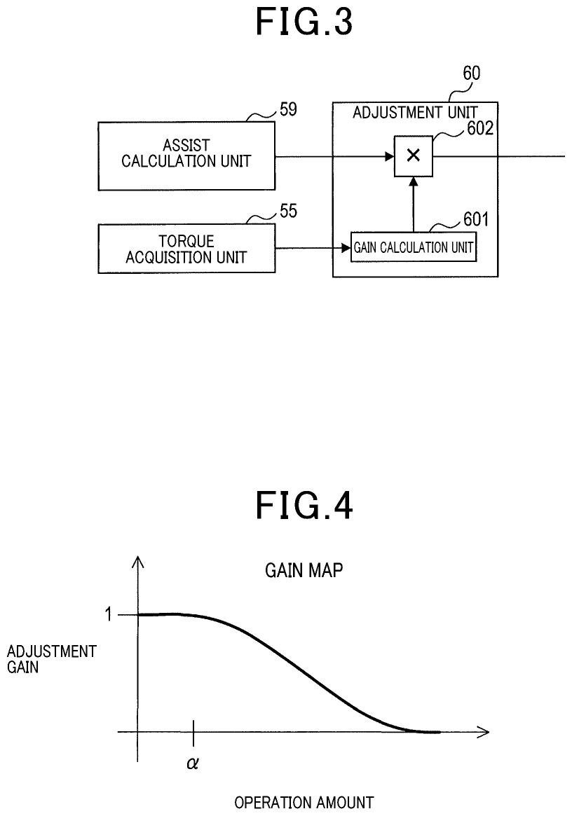

The adjustment unit 60 adjusts the assist control amount calculated by the assist calculation unit 59 according to the steering torque acquired by the torque acquisition unit 55. In other words, the adjustment unit 60 adjusts the assist control amount according to the operation amount of the steering performed by the driver. Specifically, as shown in FIG. 3, the adjustment unit 60 includes a gain calculation unit 601 and a multiplication unit 602.

The gain calculation unit 601 calculates an adjustment gain which takes a value ranging from 0 to 1 according to the steering torque.

The adjustment gain is calculated according to the gain map shown in FIG. 4. The horizontal axis of the gain map represents the operation amount performed by the driver, and in the present embodiment, it represents the steering torque. On the other hand, the vertical axis represents the adjustment gain. As can be seen from FIG. 4, when the steering torque is 0, the adjustment gain is calculated to be 1. As the steering torque increases, the calculated adjustment gain decreases. Specifically, the adjustment gain is kept at 1 in a range where the steering torque is less than or equal to a predetermined threshold α greater than 0. On the other hand, in the range where the steering torque is larger than the threshold α, the calculated adjustment gain gradually decreases (that is, monotonically decreases) as the steering torque increases. In the present embodiment, the threshold α is set as the upper limit of a range preset as the range in which the operation amount of the driver's steering operation is minute.

As described above, in the present embodiment, the steering direction of the steering torque is not considered in the calculation of the adjustment gain, and the adjustment gain is calculated based on the magnitude of the steering torque.

The multiplication unit 602 multiplies the assist control amount calculated by the assist calculation unit 59 by the adjustment gain calculated by the gain calculation unit 601. As a result, the assist control amount is adjusted.

That is, in the present embodiment, in the range where the steering torque is equal to or less than the threshold α, since the adjustment gain is 1, the assist control amount is not adjusted. On the other hand, in the range where the steering torque is larger than the threshold α, since the calculated adjustment gain gradually decreases as the steering torque increases, the assist control amount is adjusted to become smaller.

The addition unit 61 adds the basic control amount calculated by the basic calculation unit 56 and the assist control amount adjusted by the adjustment unit 60.

The execution unit 62 executes the steering control based on the control amount obtained by the addition of the addition unit 61. Specifically, the execution unit 62 executes the steering control by controlling the amount of electric power supplied to the motor 14 by the motor drive circuit 63.

The motor drive circuit 63 drives the motor 14 by supplying electric power to the motor 14.

[1-2. Process]

Next, the steering support process carried out by the EPSECU 50 will be described with reference to FIGS. 5 and 6. It should be noted that the steering support process is executed when the steering support is started, and is ended when the steering support is ended.

In S101, the EPSECU 50 acquires the traveling speed of the own vehicle from the vehicle speed sensor 20.

In S102, the EPSECU 50 acquires the map data from the map data storage device 30.

In S103, the EPSECU 50 acquires the current position of the own vehicle from the GPS receiver 40.

In S104, the EPSECU 50 acquires the steering angle from the steering angle sensor 12.

In S105, the EPSECU 50 acquires the steering torque from the torque sensor 13.

In S106, the EPSECU 50 calculates the basic control amount based on the traveling speed of the own vehicle acquired in S101 and the steering torque acquired in S105.

In S107, the EPSECU 50 calculates, based on the traveling speed of the own vehicle acquired in S101, the map represented by the map data acquired in S102, and the current position of the own vehicle acquired in S103, the predicted position is calculated.

In S108, the EPSECU 50 calculates the target steering angle based on the road shape at the predicted position that can be identified from the map represented by the map data acquired in S102.

In S109, the EPSECU 50 calculates the assist control amount based on the steering angle acquired in S104 and the target steering angle acquired in S108.

In S110, the EPSECU 50 executes the adjustment process shown in FIG. 6. The assist control amount is adjusted by executing the adjustment process.

The adjustment process will be explained.

In S201, the EPSECU 50 acquires the steering torque from the torque sensor 13.

In S202, the EPSECU 50 calculates the adjustment gain in accordance with the steering torque acquired in S201.

In S203, the EPSECU 50 multiplies the assist control amount calculated in S109 by the adjustment gain calculated in S202, thereby adjusting the assist control amount.

After executing S203, the EPSECU 50 finishes the adjustment process and proceeds to S111.

In S111, the EPSECU 50 adds the basic control amount calculated in S106 and the assist control amount adjusted in S110.

In S112, the EPSECU 50 executes the steering control based on the control amount obtained by the addition in S111. Specifically, the EPSECU 50 executes the steering control by controlling the amount of electric power supplied to the motor 14.

After executing S112, the EPSECU 50 proceeds to S101 described above. Note that, in the present embodiment, the EPSECU 50 corresponds to the steering support device, the steering torque which is the detection value of the torque sensor 13 corresponds to the operation amount of the steering performed by the driver, and the torque acquisition unit 55 corresponds to the operation amount acquisition unit. Further, S101 corresponds to the processing as the vehicle speed acquisition unit 51, S102 corresponds to the processing as the map acquisition unit 52 and the acquisition of map data, S103 corresponds to the processing as the position acquisition unit 53, and S104 corresponds to the processing as the steering angle acquisition unit 54. S105 and S201 correspond to the processing as the torque acquisition unit 55, S106 corresponds to the processing as the basic calculation unit 56, S107 corresponds to the processing as the position prediction unit 57 and the calculation of the predicted position, and S108 corresponds to the processing as the steering angle calculation unit 58. S109 corresponds to the processing as the assist calculation unit 59 and the calculation of the assist control amount, S111 corresponds to the processing as the addition unit 61, and S112 corresponds to the processing as the execution unit 62 and the execution of the steering control. S201 corresponds to the processing as the operation amount acquisition unit and the acquisition of the operation amount, S202 and S203 correspond to the processing as the adjustment unit 60 and the adjustment of the assist control amount, S202 corresponds to the processing as the gain calculation unit 601, and S203 corresponds to the processing as the multiplication unit 602.

[1-3. Effects]

According to the first embodiment described above in detail, the following effects can be obtained.

(1a) In the present embodiment, the assist control amount is adjusted according to the steering torque. In other words, the assist control amount is adjusted according to the operation amount of the steering performed by the driver. Thus, when the driver intends to respond to a situation that has not been taken into consideration in the calculation of the assist control amount performed in S109, such as when the driver abruptly performs steering operation in an attempt to avoid an obstacle, it is possible to prevent the steering operation of the driver being hindered by the steering control.

(1b) In the present embodiment, the assist control amount is adjusted using the steering torque. Thus, it is possible to alleviate the sense of discomfort the driver feels when the driver intends to respond to a situation that has not been taken into consideration in the calculation of the assist control amount.

That is, it is conceivable to adopt the lateral acceleration of the own vehicle as the information representing the operation amount of the steering performed by the driver, and adjust the assist control amount according to the lateral acceleration. However, the steering torque more accurately reflects the driver's steering operation than information such as the lateral acceleration. Therefore, by using the steering torque in the calculation of the assist control amount, it is possible to adjust the assist control amount more accurately reflecting the steering operation of the driver, as compared with the configuration using the lateral acceleration of the own vehicle. As a result, it is possible to further reduce the sense of discomfort the driver feels.

(1c) According to the configuration of the present embodiment, the more imminent the situation is to the driver, the less the driver's steering operation is hindered by the steering control.

That is, generally it can be considered that the more urgent the driver's situation, the stronger the driver rotates the steering wheel 11, and thus the steering torque increases. In the present embodiment, the greater the steering torque, the smaller the adjusted assist control amount. Accordingly, the more urgent the situation of the driver, the smaller the adjusted assist control amount, and as a result, the less the driver's steering operation is hindered by the steering control.

(1d) In the present embodiment, when the steering torque is equal to or smaller than the threshold α, the assist control amount is not adjusted. In other words, in the gain map, the range preset as a range in which the driver's operation amount is minute is set as a dead zone in which adjustment of the assist control amount is not performed.

Therefore, it is possible to prevent the assist control amount being adjusted even when the driver slightly operates the steering wheel 11 due to an erroneous operation.

[2. Second Embodiment]

[2-1. Differences from the First Embodiment]

Since the basic configuration of the second embodiment is the same as that of the first embodiment, the description of the common parts will be omitted, and the differences will be mainly described. Reference numbers that are the same as those of the first embodiment denote structures that are the same, and the preceding explanations in the present specification and the drawings should be referred to.

In the first embodiment described above, in the adjustment of the assist control amount, the adjustment gain is calculated based on the magnitude of the steering torque, and the steering direction of the steering torque is not taken into account in the calculation of the adjustment gain. On the other hand, in the second embodiment, the calculated adjustment gain differs depending on whether the steering direction of the steering torque and the steering direction of the assist control amount are the same. Note that the steering direction of the steering torque referred to here is the steering direction in which the steering torque is applied by the driver's steering operation, and it coincides with the steering direction of the driver's steering operation. Further, the steering direction of the assist control amount referred to here is the steering direction in which the steering is assisted by the steering support, that is, the direction in which the steering torque is applied by the steering support.

Specifically, the EPS system 1 of the second embodiment has the same hardware configuration as the EPS system 1 of the first embodiment described above. However, the adjustment process executed by the EPSECU 50 of the second embodiment, in other words, the function of the adjustment unit 60 is different from that of the first embodiment. The functions of the EPSECU 50 other than the adjustment unit 60, such as the vehicle speed acquisition unit 51, are the same as those of the first embodiment.

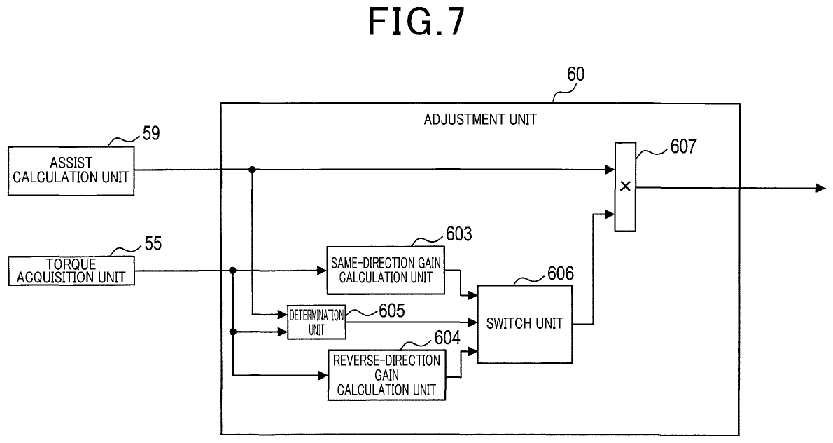

Specifically, as shown in FIG. 7, the adjustment unit 60 of the second embodiment includes, in place of the gain calculation unit 601 and the multiplication unit 602 of the first embodiment, a same-direction gain calculation unit 603, a reverse-direction gain calculation unit 604, a determination unit 605, a switch unit 606, and a multiplication unit 607.

The same-direction gain calculation unit 603 calculates the adjustment gain according to the steering torque acquired by the torque acquisition unit 55. Hereinafter, the adjustment gain computed by the same-direction gain calculation unit 603 is also referred to as “same-direction gain”. As described later, the same-directional gain is the adjustment gain used when the steering direction of the steering torque and the steering direction of the assist control amount are in the same direction.

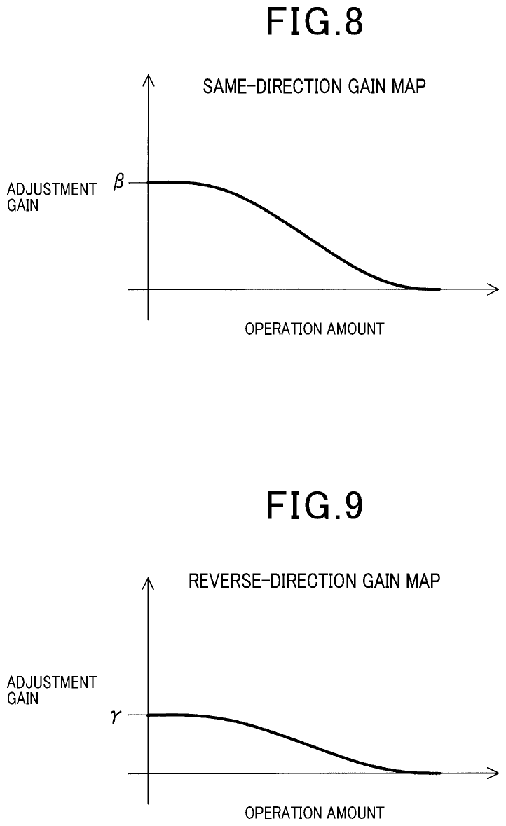

The same-direction gain is calculated according to the same-direction gain map shown in FIG. 8. As can be seen from FIG. 8, when the steering torque is 0, the same-direction gain is calculated to be a predetermined value β which is smaller than 1. As the steering torque increases, the same-direction gain decreases. In the same-direction gain map, the range of operation amount in which the adjustment gain is kept at 1, in other words, the dead zone is not set.

On the other hand, the reverse-direction gain calculation unit 604 calculates the adjustment gain according to the steering torque acquired by the torque acquisition unit 55. Hereinafter, the adjustment gain computed by the reverse-direction gain calculation unit 604 is also referred to as “reverse-direction gain”. As described later, the reverse-directional gain is the adjustment gain used when the steering direction of the steering torque and the steering direction of the assist control amount are opposite.

The reverse-direction gain is calculated according to the reverse-direction gain map shown in FIG. 9. As can be seen from FIG. 9, when the steering torque is 0, the reverse-direction gain is calculated to be a predetermined value γ which is smaller than the above-described predetermined value β. As the steering torque increases, the reverse-direction gain decreases. In particular, the reverse-direction gain is set such that, for any control amount of the driver's steering operation, i.e., any value of the steering torque greater than 0, the reverse-direction gain is smaller than the same-direction gain. Note that, also in the reverse-direction gain map, the dead zone is not set.

The determination unit 605 determines whether the steering direction of the steering torque acquired by the torque acquisition unit 55 and the steering direction of the assist control amount calculated by the assist calculation unit 59 are the same. That is, the determination unit 605 determines whether the steering direction of the driver's steering operation and the direction in which the steering is assisted by the steering support are the same.

Based on the determination result of the determination unit 605, the switch unit 606 determines the adjustment gain to be multiplied by the assist control amount as either the same-direction gain or the reverse-direction gain. Specifically, when it is determined by the determining unit 605 that the steering direction of the steering torque and the steering direction of the assist control amount are the same, the switch unit 606 sets the adjustment gain to be multiplied by the assist control amount as the same-direction gain. On the other hand, when it is determined by the determining unit 605 that the steering direction of the steering torque and the steering direction of the assist control amount are not the same, i.e., opposite, the switch unit 606 sets the adjustment gain to be multiplied by the assist control amount as the reverse-direction gain.

The multiplication unit 607 multiplies the assist control amount calculated by the assist calculation unit 59 by the adjustment gain determined by the switch unit 606. As a result, the assist control amount is adjusted. As described above, the reverse-direction gain is set to be smaller than the same-direction gain. Therefore, in the case where the steering direction of the steering torque and the steering direction of the assist control amount are opposite, the adjusted assist control amount has a smaller value as compared with the case where the steering directions are the same.

[2-2. Process]

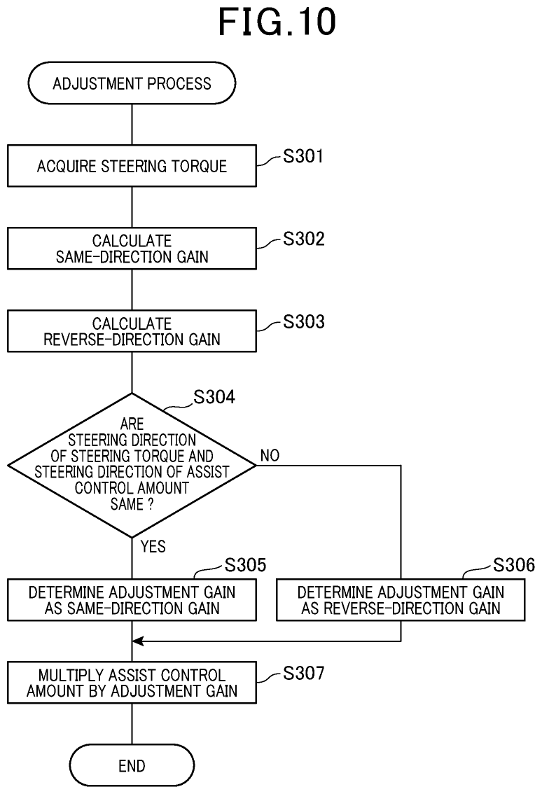

Next, the steering support process carried out by the EPSECU 50 of the second embodiment will be described. The steering support process executed by the EPSECU 50 according to the second embodiment is the same as the steering support process executed by the EPSECU 50 of the first embodiment except for the adjustment processing. Therefore, in the following, only the adjustment processing relating to the difference will be described with reference to the flowchart of FIG. 10.

In S301, the EPSECU 50 acquires the steering torque from the torque sensor 13. In S302, the EPSECU 50 calculates the same-direction gain in accordance with the steering torque acquired in S301.

In S303, the EPSECU 50 calculates the reverse-direction gain in accordance with the steering torque acquired in S301.

In S304, the EPSECU 50 determines whether the steering direction of the steering torque acquired in S301 and the steering direction of the assist control amount calculated in S109 of FIG. 5 described above are the same. When it is determined in this step S304 that the steering direction of the steering torque and the steering direction of the assist control amount are the same, the process proceeds to S305. On the other hand, when it is determined that the steering direction of the steering torque and the steering direction of the assist control amount are not the same, i.e., opposite, the process proceeds to S306.

In S305, the EPSECU 50 determines the adjustment gain to be multiplied by the assist control amount as the same-direction gain.

In S306, the EPSECU 50 determines the adjustment gain to be multiplied by the assist control amount as the reverse-direction gain.

After executing S305 or S306, the EPSECU 50 proceeds to S307.

In S307, the EPSECU 50 multiplies the assist control amount calculated in S109 of FIG. 5 described above by the adjustment gain determined in S305 or S306, thereby adjusting the assist control amount.

After executing S307, the EPSECU 50 finishes the adjustment process.

Note that, in this embodiment, S301 corresponds to the processing as the torque acquisition unit 55 and the operation amount acquisition unit, and the acquisition of the operation amount, and S302 to S307 correspond to the processing as the adjustment unit 60 and the adjustment of the assist control amount. Specifically, S302 corresponds to the processing as the same-direction gain calculation unit 603, S303 corresponds to the processing as the reverse-direction gain calculation unit 604, and S304 corresponds to the processing as the determination unit 605. In addition, S305 and S306 correspond to the processing as the switch unit 606, and S307 corresponds to the processing as the multiplication unit 607.

[2-3. Effects]

According to the second embodiment described above in detail, the following effects can be obtained in addition to the above-described effects (1a) to (1c) of the first embodiment.

According to the configuration of the present embodiment, it is possible to alleviate the resistance the driver feels due to the steering control when the driver intends to respond to a situation that has not been taken into consideration in the calculation of the assist control amount.

In other words, comparing the case where the steering direction of the driver and the steering direction of the assist control amount are the same to the case where the steering direction of the driver and the steering direction of the assist control amount are opposite, even if the assist control amount is adjusted to have the same magnitude, the resistance the driver feels will be different. More specifically, the driver feels more resistance when the steering direction of the driver and the steering direction of the assist control amount are opposite. In this regard, according to the present embodiment, in the case where the steering direction of the steering torque, i.e., the steering direction of the driver's steering operation and the steering direction of the assist control amount are opposite, the adjusted assist control amount has a smaller value as compared with the case where the steering direction of the driver's steering operation and the steering direction of the assist control amount are the same. In other words, the assist control amount is adjusted to be smaller in the case the driver would feel more resistance. Thus, it is possible to alleviate the resistance the driver feels due to the steering control when the driver intends to respond to a situation that has not been taken into consideration in the calculation of the assist control amount.

[3. Third Embodiment]

[3-1. Differences from the Second Embodiment]

Since the basic configuration of the third embodiment is the same as that of the second embodiment, the description of the common parts will be omitted, and the differences will be mainly described. Reference numbers that are the same as those of the second embodiment denote structures that are the same, and the preceding explanations in the present specification and the drawings should be referred to.

In the above-described second embodiment, the way of adjusting the assist control amount differs depending on whether the steering direction of the steering torque and the steering direction of the assist control amount are the same. The third embodiment differs from the second embodiment in that the way of adjusting the assist control amount differs depending on whether the steering direction of the steering torque and the steering direction of the motor 14 are the same.

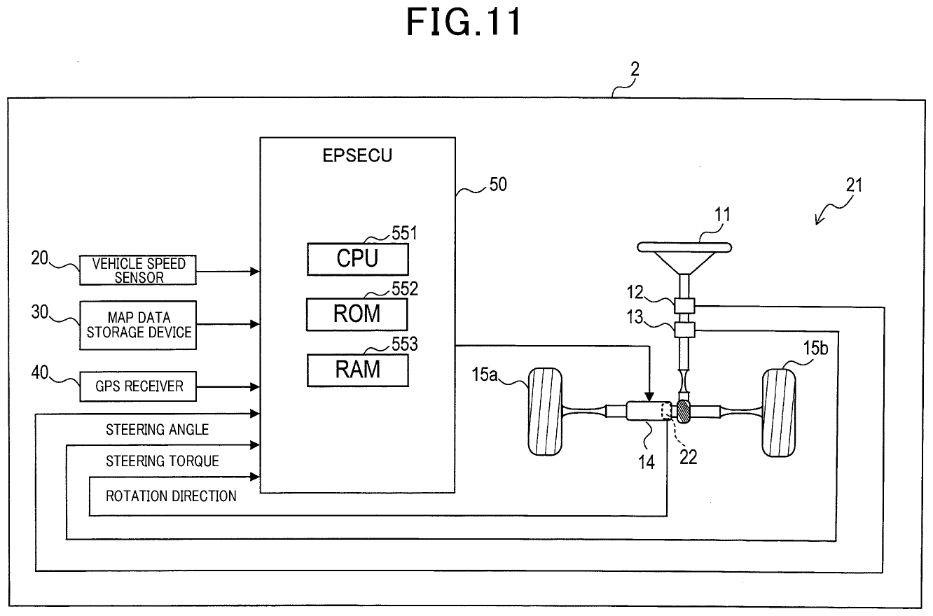

Specifically, the EPS system 2 of the third embodiment shown in FIG. 11 has a steering mechanism 21 instead of the steering mechanism 10 of the second embodiment described above. In addition, the EPSECU 50 of the third embodiment executes a process that is partly different from that of the EPSECU 50 of the second embodiment.

The steering mechanism 21 differs from the steering mechanism 10 of the second embodiment in that it further includes a rotation direction sensor 22 in addition to the above-described components from the steering wheel 11 to the steerable wheels 15a, 15b.

The rotation direction sensor 22 detects the rotation direction of the motor 14. The rotation direction sensor 22 outputs the detection result to the EPSECU 50.

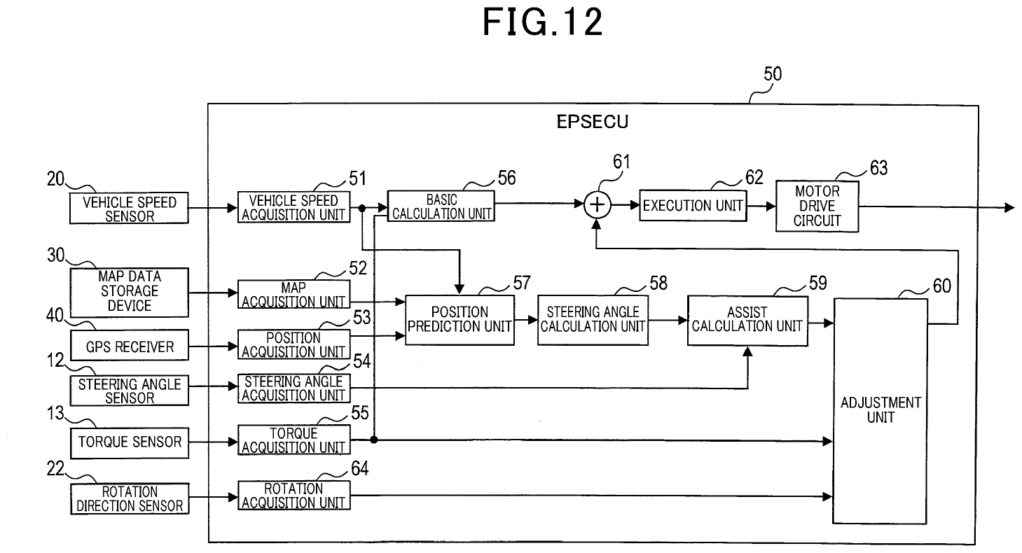

As shown in FIG. 12, the EPSECU 50 according to the third embodiment is different from the EPSECU 50 of the second embodiment in that it further has a function as a rotation acquiring unit 64 in addition to the above functions from the vehicle speed acquisition unit 51 to the execution unit 62. In addition, a part of the function of the adjustment unit 60 of the third embodiment is different from that of the adjustment unit 60 of the second embodiment.

The rotation acquiring unit 64 acquires the rotation direction of the motor 14 from the rotation direction sensor 22, in other words, the direction in which the steering torque is applied by the motor 14 (hereinafter, the steering direction of the motor 14).

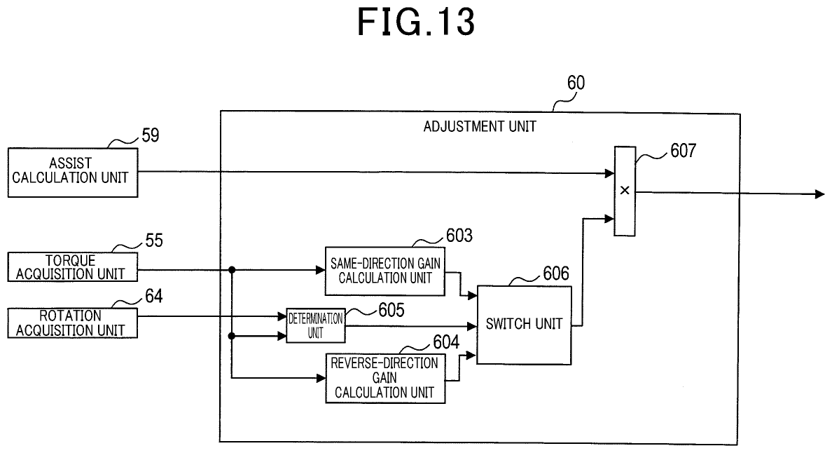

As shown in FIG. 13, the adjustment unit 60 of the third embodiment has the above-described functions from the same-direction gain calculating unit 603 to the multiplication unit 607, and among these functions, the functions of the determination unit 605 and the switch unit 606 are different from those of the adjustment unit 60 of the second embodiment.

The determination unit 605 determines whether the steering direction of the steering torque acquired by the torque acquisition unit 55 and the steering direction of the motor 14 acquired by the rotation acquisition unit 64 are the same.

Based on the determination result of the determination unit 605, the switch unit 606 determines the adjustment gain to be multiplied by the assist control amount as either the same-direction gain or the reverse-direction gain. Specifically, when it is determined by the determining unit 605 that the steering direction of the steering torque and the steering direction of the motor 14 are the same, the switch unit 606 sets the adjustment gain to be multiplied by the assist control amount as the same-direction gain. On the other hand, when it is determined by the determining unit 605 that the steering direction of the steering torque and the steering direction of the motor 14 are not the same, i.e., opposite, the switch unit 606 sets the adjustment gain to be multiplied by the assist control amount as the reverse-direction gain.

[3-2. Process]

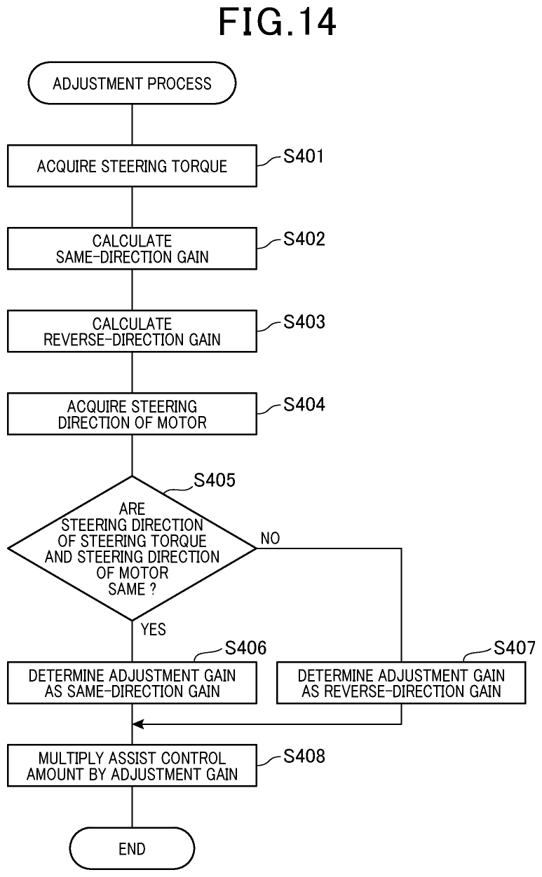

Next, the steering support process carried out by the EPSECU 50 of the third embodiment will be described. The steering support process executed by the EPSECU 50 according to the third embodiment is the same as the steering support process executed by the EPSECU 50 of the second embodiment except for the adjustment processing. Therefore, in the following, only the adjustment processing relating to the difference will be described with reference to the flowchart of FIG. 14.

S401 to S403 are the same as S301 to S303 of FIG. 10 described above, respectively, and thus explanations thereof will be omitted.

In S404, the EPSECU 50 acquires the rotation direction of the motor 14 from the rotation direction sensor 22, in other words, the steering direction of the motor 14.

In S405, the EPSECU 50 determines whether the steering direction of the steering torque acquired in S401 and the steering direction of the motor 14 acquired in S404 are the same. When it is determined in this step S405 that the steering direction of the steering torque and the steering direction of the motor 14 are the same, the process proceeds to S406. On the other hand, when it is determined that the steering direction of the steering torque and the steering direction of the motor 14 are not the same, i.e., opposite, the process proceeds to S407.

S406 to S408 are the same as S305 to S307 of FIG. 10 described above, respectively, and thus explanations thereof will be omitted.

Note that S401 corresponds to the processing as the torque acquisition unit 55 and the operation amount acquisition unit, and the acquisition of the operation amount, S404 corresponds to the processing as the rotation acquisition unit 64, and S402, S403, and S405 to S408 correspond to the processing as the adjustment unit 60 and the adjustment of the assist control amount. Specifically, S402 corresponds to the processing as the same-direction gain calculation unit 603, S403 corresponds to the processing as the reverse-direction gain calculation unit 604, and S405 corresponds to the processing as the determination unit 605. In addition, S406 and S407 correspond to the processing as the switch unit 606, and S408 corresponds to the processing as the multiplication unit 607.

[3-3. Effects]

According to the third embodiment described above in detail, the following effects can be obtained in addition to the above-described effects (1a) to (1c) of the first embodiment.

According to the present embodiment, in the case where the steering direction of the steering torque, i.e., the steering direction of the driver's steering operation and the steering direction of the motor 14 are opposite, the adjusted assist control amount has a smaller value as compared with the case where the steering direction of the driver's steering operation and the steering direction of the assist control amount are the same. Therefore, the present embodiment produces the same effects as those of the above-described second embodiment.

[4. Other Embodiments]

Embodiments for implementing the present disclosure has been described above, but the present disclosure is not limited to the above-described embodiments and can be implemented with various modifications.

(4a) In the above embodiments, the greater the steering torque, i.e., the operation amount of the steering performed by the driver, the smaller the adjusted assist control amount.

However, the way of adjusting the assist control amount is not limited to this. For example, the assist control amount may be adjusted by being reduced uniformly, for example, the assist control amount may be multiplied by a constant adjustment gain irrespective of the magnitude of the operation amount of the driver's steering operation. In this case, the assist control amount is adjusted depending on the presence/absence of the operation amount of the steering performed by the driver.

(4b) In the first embodiment, a dead zone is set in the gain map, and in the second and third embodiments, no dead zone is set in either of the same-direction gain map and the reverse-direction gain map. However, the presence/absence of the dead zone is not limited to this.

For example, in the first embodiment, the dead zone may not be set in the gain map. As another example, in the second and third embodiments, a dead zone may be set in at least one of the same-direction gain map and the reverse-direction gain map.

(4c) In the above-described embodiments, the steering torque which is the detection value of the torque sensor 13 is exemplified as the operation amount of the steering performed by the driver, but the operation amount is not limited to this. The operation amount of the driver's steering operation may be, for example, the rotation speed of the steering wheel 11, the rotation speed of the motor 14, or the like. These configurations also allow the assist control amount to be adjusted more accurately reflecting the steering operation of the driver, as compared with the configuration using, for example, the lateral acceleration of the own vehicle as the operation amount of the steering performed by the driver. As a result, it is possible to further reduce the sense of discomfort the driver feels.

(4d) In the above-described embodiments, a single kind of information such as the steering torque is used as the operation amount of the steering performed by the driver, but the number of the information used as the operation amount is not limited to this. For example, the operation amount of the driver's steering operation may include multiple kinds of information such as both the steering torque and the rotation speed of the motor 14. In such case, the assist control amount may be adjusted according to the multiple kinds of information.

(4e) In the above embodiments, some or all of the functions executed by the EPSECU 50 may be configured in a hardware manner, for example, by one or more ICs. In this case, for example, the functions of the map acquisition unit 52, the position acquisition unit 53, the position prediction unit 57, and the steering angle calculation unit 58 may be configured by devices external to the EPSECU 50.

(4f) Aside from the above-described EPSECU 50, the present disclosure may be realized in various forms such as the EPS system 1, 2 comprising the EPSECU 50 as a component, a program for causing a computer to function as the EPSECU 50, a non-transitory tangible computer-readable storage medium such as a semiconductor memory storing the program, and a method for adjusting the assist control amount according to the operation amount of the steering performed by the driver.

(4g) A plurality of functions realized by a single component of the above embodiments may be realized by a plurality of components, or a single function realized by a single component may be realized by a plurality of components. Further, a plurality of functions realized by a plurality of components may be realized by a single component, or a single function realized by a plurality of components may be realized by a single component.

Furthermore, a part of the configuration of the above embodiments may be omitted. Furthermore, at least a part of the configuration of one of the above embodiments may be added or substituted in the configuration of another of the embodiments described above. Embodiments of the present disclosure include any mode included in the technical spirit specified by the language of the claims.

1. A steering support device configured to support a steering operation made by a driver of a vehicle, comprising:
a map acquisition unit which acquires map data representing a map;
a position prediction unit which calculates a predicted position which is a position of the vehicle on the map at a certain point of time after the present time based on the map;
an assist calculation unit which calculates an assist control amount of the steering operation based on a road shape at the predicted position which can be identified from the map;
an operation amount acquisition unit which acquires an operation amount of the steering;
an adjustment unit which adjusts the assist control amount according to the operation amount; and
an execution unit which executes a steering control based on the assist control amount adjusted by the adjustment unit.

2. The steering support device according to claim 1, further comprising
a position acquisition unit which acquires a current position of the vehicle,
a steering angle acquisition unit which acquires a steering angle of a steering wheel of the vehicle, and
a steering angle calculation unit which calculates a target steering angle which is the steering angle to be achieved, based on the road shape at the predicted position which can be identified from the map, wherein
the position prediction unit calculates the predicted position based on the current position and the map, and
the assist calculation unit calculates the assist control amount based on the steering angle acquired by the steering angle acquisition unit and the target steering angle calculated by the steering angle calculation unit.

3. The steering support device according to claim 1, wherein
the operation amount includes at least one of a rotation speed of a steering wheel of the vehicle, a detection value of a torque sensor which detects a steering torque applied to the steering wheel, and a rotation speed of a motor which generates an auxiliary steering torque according to the steering torque.

4. The steering support device according to claim 1, wherein
the adjustment unit adjusts the assist control amount such that the assist control amount decreases as the operation amount increases.

5. The steering support device according to claim 1, wherein
when a steering direction of the operation amount and a steering direction of the assist control amount are opposite, the adjustment unit adjusts the assist control amount to a smaller value as compared with when the steering direction of the operation amount and the steering direction of the assist control amount are the same.

6. The steering support device according to claim 1, wherein
when a steering direction of the operation amount and a steering direction of a motor configured to generate an auxiliary steering torque according to a steering torque applied to a steering wheel of the vehicle are opposite, the adjustment unit adjusts the assist control amount to a smaller value as compared with when the steering direction of the operation amount and the steering direction of the motor are the same.

7. The steering support device according to claim 1, wherein
the adjustment unit does not adjust the assist control amount when the operation amount is equal to or smaller than a predetermined threshold.

8. A steering support method executed by a steering support device configured to support a steering operation made by a driver of a vehicle, comprising:
acquiring map data representing a map;
calculating a predicted position which is a position of the vehicle on the map at a certain point of time after the present time based on the map;
calculating an assist control amount of the steering operation based on a road shape at the predicted position which can be identified from the map;
acquiring an operation amount of the steering;
adjusting the assist control amount according to the operation amount; and
executing a steering control based on the adjusted assist control amount.

9. The steering support device according to claim 1, wherein
the adjustment unit adjusts the assist control amount by multiplying the assist control amount by an adjustment gain corresponding to the operation amount,
when a steering direction of the operation amount and a steering direction of the assist control amount are the same, the adjustment unit calculates the adjustment gain corresponding to the operation amount according to a first gain map, and when the steering direction of the operation amount and the steering direction of the assist control amount are opposite, the adjustment unit calculates the adjustment gain corresponding to the operation amount according to a second gain map that is different from the first gain map, and
the first gain map and the second gain map are maps in which the adjustment gain corresponding to the operation amount is set.

10. The steering support device according to claim 1, wherein
the adjustment unit adjusts the assist control amount by multiplying the assist control amount by an adjustment gain corresponding to the operation amount,
when a steering direction of the operation amount and a steering direction of a motor for generating an auxiliary steering torque corresponding to a steering torque applied to the steering wheel are the same, the adjustment unit calculates the adjustment gain corresponding to the operation amount according to a first gain map, and when the steering direction of the operation amount and the steering direction of the motor are opposite, the adjustment unit calculates the adjustment gain corresponding to the operation amount according to a second gain map that is different from the first gain map, and
the first gain map and the second gain map are maps in which the adjustment gain corresponding to the operation amount is set.

11. The steering support device according to claim 9, wherein
the first gain map and the second gain map are set such that the adjustment gain corresponding to a common operation amount is smaller in the second gain map than in the first gain map.

12. The steering support device according to claim 11, wherein
the first gain map and the second gain map are both set such that the larger the operation amount, the smaller the adjustment gain.
